(19) United States
(12) Patent Application Publication
(10) Pub. No.: US 2008/0231644 A1
(43) Pub. Date: Sep. 25, 2008

(54) METHOD AND SYSTEM FOR NAVIGATION OF TEXT

(76) Inventors: Ronny Lempel, Haifa (IL); Elad Shahar, Rehovot (IL)

Correspondence Address: Suzanne Erez;IBM CORPORATION, Intellectual Property Law Dept., P.O. Box 218, Yorktown Heights, NY, 10598, US

(21) Appl. No.: 11/688,272

(22) Filed: Mar. 20, 2007

(51) Int. Cl. G09G 5/00

(52) U.S. Cl. 345/689

(57) ABSTRACT

A method and system for navigation of text are provided. A linear text (110) in electronic form is selected. The system includes a display (131) of a plurality of phrases representing the content of the text (110) with means for emphasizing a displayed phrase to indicate the relevance of the phrase in a predefined portion of the text (110). For example, the emphasizing may be by size or color of the representation of the phrase in the display (131). The display (131) of phrases is animated (123) to show changes in the emphasizing during progression through the linear text (110). When a phrase is present in the display (131) of phrases, the phrase is kept in the same position in the display (131) during the animation. If phrases are added to and removed from the display (131) during progression through the text (110), then the method includes minimizing discontinuity of the animation.

### FIELD OF THE INVENTION

This invention relates to the field of navigation of text. In particular, the invention relates to navigation of linear text in electronic form.

### BACKGROUND OF THE INVENTION

Most people find that navigating a book or a long text in paper form is still more pleasing than reading these in electronic form on screen. One reason for this is that skimming a real book is easier since it is possible to jump quickly back and forward and to flip through a series of pages, with fine control over the speed with which the pages are flipped. However, these skimming techniques are limited since one cannot quickly read the entire contents of a page. When quickly skimming to find a page of interest one can only read a limited amount of words on a page, and they might not be the most informing ones.

Traditional aids in navigation of text in electronic form include tables of contents, indexes, and bookmarks. Tables of contents and indexes are technologies which were developed for easier navigation in books. However, not all texts include tables of contents or indexes. Texts which do include them may have the problem that they are not of sufficient resolution. For example, a table of contents may only contain pointers to large sections and chapters without further partitioning. Furthermore, the wording of a table of contents may not be clear enough for a first time reader to estimate which parts of the book contains items of interest to the reader.

Bookmarks can only be used after the person has detected a place of interest. Typically, the number of bookmarks a user may put in a book is limited and cannot be relied on for navigation of the entire book.

Search can be used to find items in text in electronic form which the user is interested in. This is good if one has an idea of what one is looking for. However, skimming a book is frequently about finding what the book is about and stopping when finding something of interest—which may be unexpected.

A tag cloud (or weighted list in visual design) can be used as a visual depiction of content tags used on a web site. Often, more frequently used tags are depicted in a larger font or otherwise emphasized, while the displayed order is generally alphabetical. Thus, both finding a tag by alphabet and by popularity is possible. Selecting a single tag within a tag cloud will generally lead to a collection of items that are associated with that tag.

Tag clouds are a way to provide a terse overview of a large body of text by presenting a list of words in different sizes, which indicate the frequency or popularity of the words. This is typically used on the web for tracking the popular topics which are being bookmarked or discussed. Tag clouds may be animated to show a progression of tag popularity over time. In these animations, the tags change as different tags become popular over time resulting in a very jumpy animation.

Amazon.com, Inc. uses statistically improbably phrases (SIP) which are a collection of phrases which are unique to a book. This provides some indication of the topics which the entire book is about, but has little use for navigation inside the book. Amazon Concordance (trade marks of Amazon.com, Inc.) is a topic cloud in the form of an alphabetized list of the most frequently occurring words in a book with the font size of a word proportional to the number of times it occurs in the book. A similar concept is used in web sites which present word clouds as a visual depiction of frequently used words in the web site.

ThemeRiver (a trade mark of Pacific Northwest National Laboratory) (see http://www.pnl.gov/infoviz/technologies.html) is a visualization which helps users identify time-related patterns, trends, and relationships across a large collection of documents. The themes in the collection are represented by a “river” that flows left to right through time. The river widens or narrows to depict changes in the collective strength of selected themes in the underlying documents. This is an interesting visualization, but it is not intended for use over a single document.

Electronic pages of text may include indicators which make skimming easier. For example Xlibris (a trade mark of FX Palo Alto Laboratory) (see http://www.fxpal.com/?p=xlibris) is a type of reader that supports the highlighting of key phrases on the display of a page of text. This may be appropriate for slow skimming, but the amount of information on the page and the fact that the locations of highlighted text on each page change make it inappropriate for faster skimming.

### SUMMARY OF THE INVENTION

The invention aims to provide a user interface which facilitates fast navigation or skimming over linear text. The invention provides a method and tool for presentation and animation of phrase clouds for the use of navigation of electronic linear text.

According to a first aspect of the present invention there is provided a method for navigation of text, comprising: providing a linear text in electronic form; displaying a plurality of phrases representing the content of the text; emphasizing a displayed phrase to indicate the relevance of the phrase in a predefined portion of the text; and animating the display of phrases to show changes in the emphasizing during progression through the linear text.

According to a second aspect of the present invention there is provided a system for navigation of linear text in electronic form, comprising: a user interface for displaying a plurality of phrases representing the content of the text, including means for progressing though the linear text; means for emphasizing a displayed phrase to indicate the frequency of the phrase in a predefined portion of the text; and means for animating the display of phrases to show changes in the emphasizing during progression through the linear text.

According to a third aspect of the present invention there is provided a computer program product stored on a computer readable storage medium for navigation of text, comprising computer readable program code means for performing the steps of: providing a linear text in electronic form; displaying a plurality of phrases representing the content of the text; emphasizing a displayed phrase to indicate the frequency of the phrase in a predefined portion of the text; and animating the display of phrases to show changes in the emphasizing during progression through the linear text.

### BRIEF DESCRIPTION OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings in which:

FIG. 1 is a block diagram of a system in accordance with the present invention;

FIG. 2 is a block diagram of a computer system in which the present invention may be implemented;

FIG. 3 is a representation of a graphical user interface in accordance with the present invention; and

FIG. 4 is a flow diagram showing a method in accordance with the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The described system uses phrase clouds to support navigation in linear texts in electronic form. The most obvious example of a linear text is a book or document with linear text running over multiple pages. For example, a Portable Document Format (PDF) book or document provides text captured as pages. Help to navigate between different pages is desired.

The described system is appropriate for any narrative with some continuity in its text, i.e. when key phrases/entities/concepts gradually increase or decrease in use. This is referred to as linear text. Therefore, the system is relevant to books, documents, articles, and web pages but will also work also for other forms of text, such as text streams. One example of another form of text is fast access to RSS (Really Simple Syndication) feeds relating to similar topics. Another example, is a news search in which references to a developing news story that is captured in many news articles (even in the same paper) are sorted by date and scanned with a separate tool in order to generate a linear story.

A browsing unit is a unit of text which can be displayed on the electronic apparatus being used to view the text. A browsing unit is most commonly a page, although it may be a section, or paragraph, etc. For apparatus with smaller viewing capabilities, a browsing unit may be a smaller unit of text. In some cases, the linear text may be continuous and not divided into units, with a portion of the text displayed at any time.

A tool for displaying linear text is provided, such as a text viewer, or web browser. The tool has means to change the content of the current browsing unit of the linear text and to display that browsing unit. Part of the displayed browsing unit may be shown if the browsing unit is too large for the display, with a scrollbar provided to move around the browsing unit. The described system works with this tool, or is embedded in it.

The main concept which helps skimming is that of animating, or “playing” a phrase cloud for the browsing unit, most commonly for a page. For each page in the text, and for each of a set of phrases, the degree to which that page and nearby pages discuss that phrase is calculated. The cloud is then animated by changing the emphasis of the phrases according to the current page in the book. The emphasis may be changed by visually highlighting a phrase using size, color, etc. The user can then detect pages where the words of interest are emphasized, and request to view those pages. The words in the cloud remain in the same place in the entire animation, making it easy to quickly skim over the entire book.

The described method and system provide the user an overview of how the topic focus varies across an entire linear text. It is aimed at being similar to taking a book and flipping the pages quickly; however, it is more useful, because flipping the real pages quickly would not allow the user to have a phrase overview as provided.

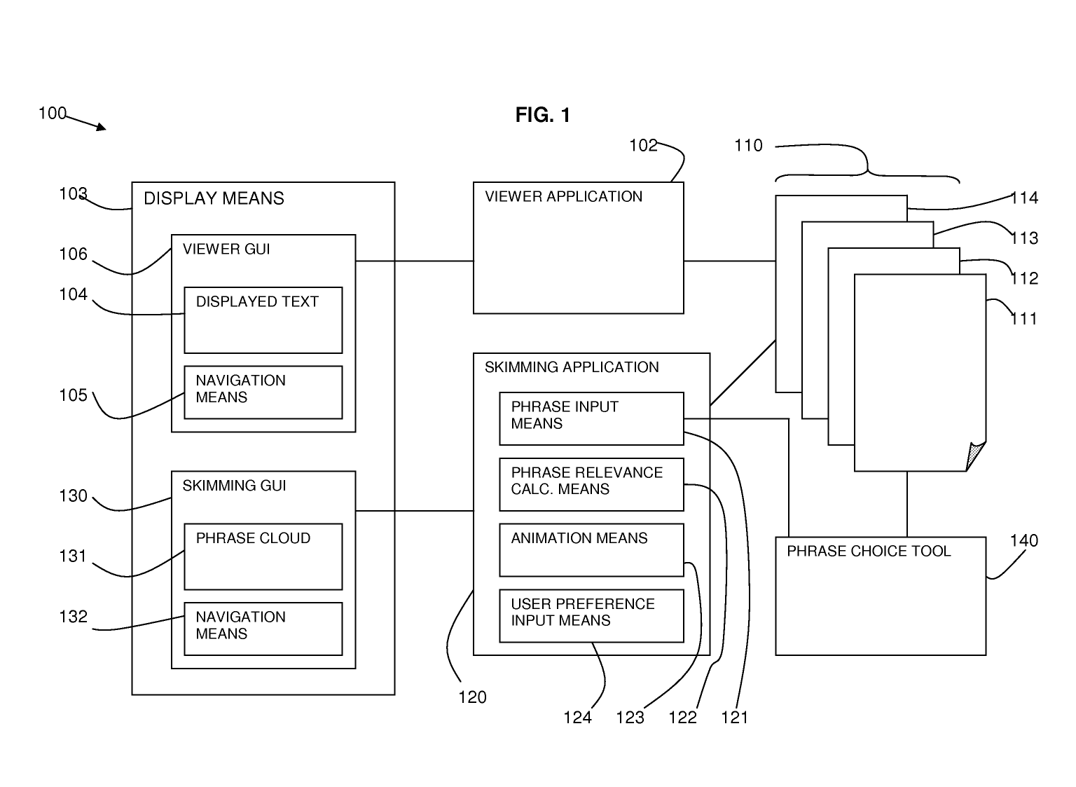

Referring to FIG. 1, a block diagram shows a system 100 with a viewer application 102 for viewing and navigating through linear text 110. The linear text 110 is provided with multiple browsing units such as pages 111-114, although the linear text 110 may be a continuous document which is not divided into browsing units.

The viewer application 102 is coupled to a display means 103 and a viewer graphical user interface (GUI) 106 shows displayed text 104 such as a current page 111-114 or part of the linear text 110. The viewer GUI 106 includes navigation means 105 such as scrollbars for moving around the displayed text 104.

A skimming application 120 is provided which may be provided integrally to the viewer application 102 or as a separate application working in conjunction with the viewer application 102. The skimming application 120 provides a skimming GUI 130 including a navigation means 132.

The skimming display 130 includes a window 131 showing a representation of a phrase cloud for the linear text 110. The window 131 may also include a display of the current text of the linear text which the phrase cloud is referring to.

The skimming application 120 includes a phrase input means 121, a phrase relevance calculation means 122, an animation means 123, and a user preference input means 124.

The skimming application 120 requires as an input in the input means 121 a list of phrases to be animated. This list can be generated using pre-existing methods with user guidance, in order to identify words that help to navigate the text. A phrase may be a single word or multiple words. It may also be a partial word or a combination of partial words. There may be a phrase generating tool 140 which automatically or semi-automatically, with some input from the author of the linear text 110, generates phrases from the linear text 110 which help navigation through the linear text 110.

The visualization/animation is done in the window 131 which presents the phrases from the text which are given as the input. The list of phrases is displayed in what is referred to as a cloud. The cloud may display the phrases in different forms, the most straightforward being in an alphabetical arrangement. The cloud is animated by highlighting the phrases as the text is scrolled or browsed. The phrases may be highlighted, for example by size or color, showing their frequency in a browsing unit and in neighbouring browsing units to create an animation. Each phrase is in a fixed position within the phrases to provide a smooth animation.

The phrases are displayed at fixed positions in the window, but may change their size. The size of a phrase in the cloud is roughly a function of the number of occurrences in the current page and nearby pages. The larger a phrase is displayed the more relevant it is to the current page or to a page which is nearby.

The user can navigate the skimming display 130 using the navigation means 132 to drag a scrollbar, or “play” the cloud to animate it. Using the navigation means 132 (e.g. cloud scrollbar, play, etc.) continuously changes the current page which is displayed in the window 131. It should be noted that changing the current page which is displayed in the window 131 of the skimming display is separate from the navigational means 105 for the displayed text 104 as part of the viewer application 102 which changes the currently displayed browsing unit of the linear text 110.

The size of phrases is determined in a way that animates smoothly. Phrase sizes do not change abruptly and this makes the animation meaningful since the continuous animation allows the user to interpret the cloud animation of dragging through a group of pages. This also allows the user, who is viewing the cloud, to determine that a phrase of medium size means that it occurs nearby, and that it may be reached by dragging the scrollbar a little forward or backward, until the size of the phrase in the cloud is large.

During animation of the cloud in the window 131 of the skimming display 130, the current page which is displayed in the displayed text 104 by the viewer application 102 may not change. However, when the cloud is not animated, the cloud which is displayed in the window 131 of the skimming display 130 would typically refer to the same page/browsing unit of the displayed text 104 of the viewer application 102. A typical scenario would be that the user drags the scrollbar of the skimming display 130 to find where phrases of interest become larger, during this time the phrase cloud changes, but the page in the displayed text 104 by the viewer application 102 may not change. Eventually, the user stops dragging when he believes the page currently presented in the cloud may be of interest. At this point the page in the viewer application 102 is updated to show the page currently presented by the cloud.

In books there is relatively very little data on each page. Even if several pages talk about a specific topic, the phrase which defines the topic may not appear on all pages. So smoothing the size of phrases in phrase clouds addresses a problem which is present in books. Phrase clouds assume text flow, and rely on this assumption to do smoothing—i.e. if a phrase appears in a nearby page, it will appear larger than usual even though the current page does not contain the phrase. The idea is that even though the current page does not contain that phrase, the content of the current page is likely to be related due to text flow.

The list of phrases could be determined either in advance, or it could be dynamically constructed while displaying the animation. Dynamic construction may adapt to the personal preferences of the user, his context, previously used search queries, topics of personal interest, etc. The list could be constructed automatically, manually, or by a combination of automatic construction with user intervention.

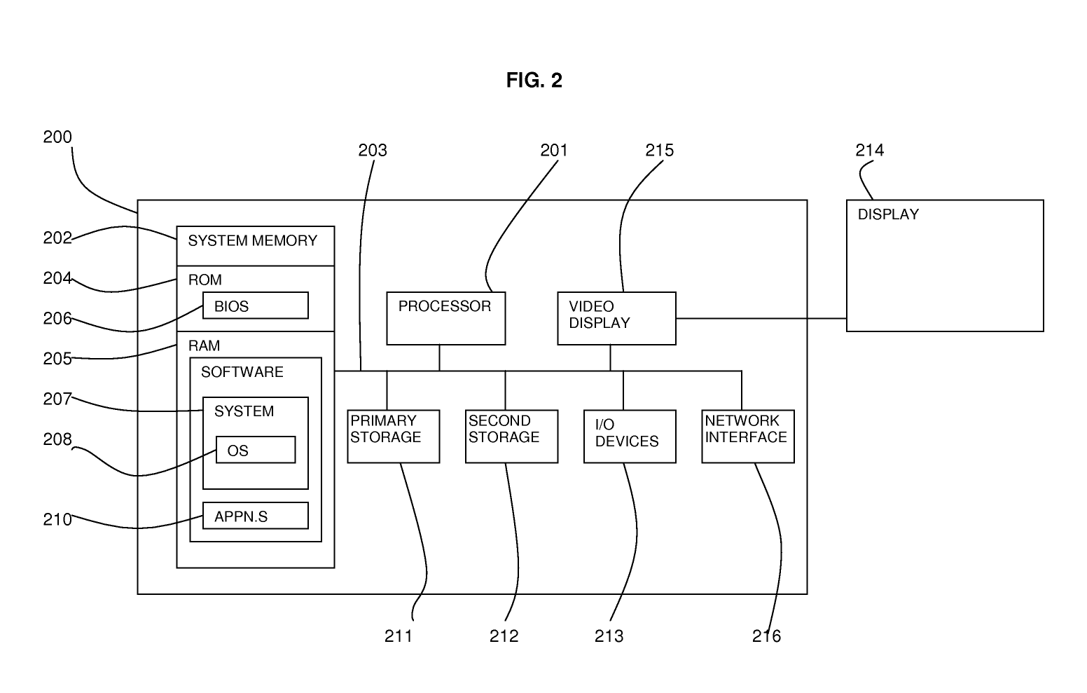

Referring to FIG. 2, an exemplary system in which the described system may be implemented is shown and includes a data processing system 200 suitable for storing and/or executing program code including at least one processor 201 coupled directly or indirectly to memory elements through a bus system 203. The memory elements can include local memory employed during actual execution of the program code, bulk storage, and cache memories which provide temporary storage of at least some program code in order to reduce the number of times code must be retrieved from bulk storage during execution.

The memory elements may include system memory 202 in the form of read only memory (ROM) 204 and random access memory (RAM) 205. A basic input/output system (BIOS) 206 may be stored in ROM 204. System software 207 may be stored in RAM 205 including operating system software 208. Software applications 210 may also be stored in RAM 205.

The system 200 may also include a primary storage means 211 such as a magnetic hard disk drive and secondary storage means 212 such as a magnetic disc drive and an optical disc drive. The drives and their associated computer-readable media provide non-volatile storage of computer-executable instructions, data structures, program modules and other data for the system 200. Software applications may be stored on the primary and secondary storage means 211, 212 as well as the system memory 202.

The computing system 200 may operate in a networked environment using logical connections to one or more remote computers via a network adapter 216.

Input/output devices 213 can be coupled to the system either directly or through intervening I/O controllers. A user may enter commands and information into the system 200 through input devices such as a keyboard, pointing device, or other input devices (for example, microphone, joy stick, game pad, satellite dish, scanner, or the like). Output devices may include speakers, printers, etc. A display device 214 is also connected to system bus 203 via an interface, such as video adapter 215.

### Example of a User Interface

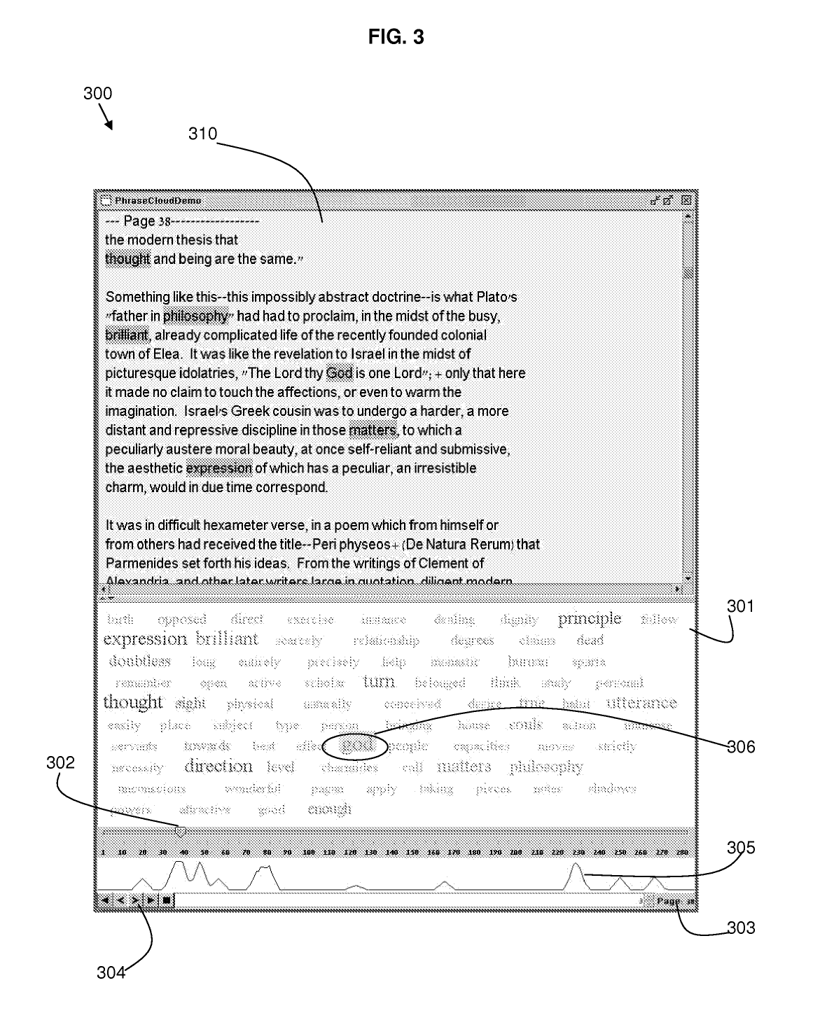

Referring to FIG. 3, a representation of a user interface display 300 for the skimming application is provided. The display 300 is in the form of a dialog window, the main portion of which displays the phrase cloud 301. The dialog window also includes a display of the current text 310 (a page, portion or a page, or other browsing unit) to which the phrase cloud 301 refers. The phrases in the current text 310 which are shown in the cloud 301 are highlighted in the current text 310.

Below the phrase cloud 301 there is a bar (or a slider) 302 which shows the current location within the linear text. There is a text field/button 303 which displays the number of the current page inside the linear text. There are also play, stop, end, next page, previous page buttons 304 for operating the skimming display.

A graph window 305 below the bar 302 is aligned exactly to span the entire bar 302 and shows a graph of the score of a selected phrase 306 across the entire book. The graph can be used to find the location of a selected word 306 in the linear text.

Pressing play in the buttons 304 changes the current page which is displayed by the cloud 301. When pressing play in the buttons 304, the sizes of the phrases change according to the new current page. The location of the phrases do not change, and they are sorted, for example, alphabetically. When a phrase is large, it means that it appears at or near the current page. The larger the phrase, the closer the current page is to a page which refers to the phrase. The size of the phrase is also affected by the number of occurrences of the phrase in the vicinity of the current page. The playing speed can be set by the user. Pressing the play button 304 does not change the display of the pages of the linear text in the current text 310, it just animates the cloud 301. When the animation is stopped by the user, the current page is displayed in the current text 310.

In a first embodiment, an additional feature could provide an indication of whether the score of a phrase grows or shrinks in previous or next pages. This could be done, for example, by vertically stretching or shrinking the beginning and end of the phrase, or by adding additional size-changing arrows on each side of the phrase.

In another embodiment, it may be that for a specific page, a phrase has a high score, but the phrase does not actually appear in that page, but in pages nearby. If the current page actually contains the phrase, the phrase will be presented differently in the cloud (e.g., a different color, or underline).

Clicking on a location in the bar 302 updates the phrase cloud 301, the current text 310, and optionally the page displayed in the viewer application. Dragging the bar 302 updates the phrase cloud 301 and optionally the current text 310 continuously. Releasing the bar 302 also updates the current text 310, and optionally the viewer application to display the corresponding page.

Dragging a user's pointer device such as a mouse in the graph section 305 defines a segment of the book to be animated. When the pointer device is released, the segment is set, and is automatically animated. Pressing the play button 304 will present the animation limited to the same segment. Clicking in the graph section 305 cancels the segment definition. Thus, future clicking of play button 304 will again animate the entire book.

### Actions on Phrases in the Cloud

There are many different ways to activate a user's pointer device, for example, a mouse-click (different buttons, double click, etc). In the following different kinds of activation are referred to as “click #n”.
The user can change the amount of phrases he wants to see in the phrase cloud.
Click #1 on a phrase in the cloud selects the phrase, and displays a graph in the graph window, which plots the score of that phrase over the entire book. The graph is displayed in a Cartesian coordinate system, where the X axis ranges over the pages of the book (so the width of the graph corresponds to the entire book's length), and the Y axis ranges over possible scores of the phrase.
Click #2 on a phrase switches the viewer to the page where the phrase has the highest score.
Click #3 switches to a search results page where the phrase serves as the query.
Hovering over a phrase shows an additional user interface for it, for example, as small arrow buttons before and after the phrase. Clicking on one of the arrows will jump the navigation to the next/previous local maximum for that phrase or to the next/previous occurrence.
When using any of the above methods for changing page number, the phrase is highlighted in the viewer.

### Changing the List of Phrases in the Cloud

The set of words which are shown in the cloud may be the same for all pages, or it may be that after some pages a word is removed and replaced by another word. If one looks at a typical index of a book, most of the words are of importance only in a very limited number of pages. If such words are included in the cloud, then they will only be larger in a very small percentage of the entire book, and thus not very useful for navigation. However, such words could be removed from the cloud when they are less useful, and replaced by other words, while still trying to minimize discontinuity in the animation.

In a further embodiment, the cloud visualization is divided into horizontal layers, one on top of the other. The upper layer contains phrases which correspond to broad themes which appear throughout a book, and it may display the same set of phrases throughout the entire visualization of the book. The lower layers contain clouds of phrases which appear in increasingly smaller sections of the book. Thus, the graph of such phrases typically forms a spike, where most of the graph is very low or even zero, and only in one place, there is a high continuous peak. Since the phrase only appears in a limited part of the book, it becomes useless in large portions of the book. The aim is to show the “spiked” phrases only when they are useful. When one spiked phrase has a low value, it is removed from the cloud, and replaced by another phrase which is relevant to the current location in the book.

Sorting the phrases in lower layers is problematic, since when phrases are replaced the new phrase may need to be relocated to a new place in the list of sorted words. This can change the positioning of the phrase in the cloud, and thus cause a large appearance of discontinuity in the animation. To maintain smoother animation, the relocation of words can be animated smoothly, or, alternatively, the sorting of the phrases can be abandoned, and when a phrase is replaced, the new phrase would be positioned at the same location of the old phrase.

The intended user experience of viewing such a cloud is that the upper layers would track broad themes of the book, and would have very smooth animation—since phrases are not replaced. Middle layers would track themes which correspond to chapters, or sections in the book. Lower layers would track specific and limited prominent topics. Animation would become more discontinuous in the lower layers due to higher replacement of words. Thus, the user should be able to focus on the upper levels to find general topics of interest, and—once these have been located—move the focus to the lower levels to find more specific and detailed topics of interest.

### Example Method

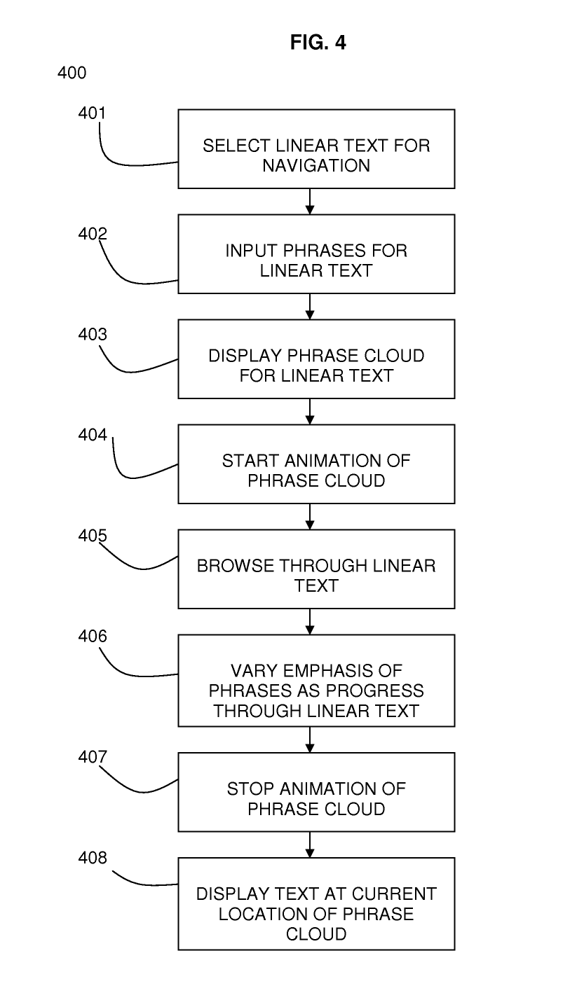

Referring to FIG. 4, a flow diagram 400 of the described method is shown. A linear text is selected 401 for navigation using the skimming application. The phrases being used to aid navigation of a linear text are input 402 into the skimming application. A display shows 403 phrases in a phrase cloud.

The animation of the phrase cloud is started 404 and the skimming application browses 405 through the linear text, as it progresses through the linear text the emphasis of the phrases is varied 406 as the phrases vary in relevance in the text. When, the animation of the phrase cloud is stopped 407, the display jumps 408 to the portion of text at the stopping place.

The following are possible solutions for several technical implementation issues.

### Defining the Phrase Scoring Function

For a given phrase, the phrase scoring function assigns a value for each page. It is desirable to have a smooth phrase scoring function—if the function is jagged the cloud animation will be jumpy, and will force the reader to view page by page in order to find items of interest. A phrase scoring function which simply assigns values according to the number of occurrences of phrases on a page is likely to be jagged.

One way to create a smooth function is to set its values such that even if the phrase actually appears several pages away from the current page, the function value will begin to increase, so that the form of highlighting will start. For example, if the highlighting is size, the phrase will be bigger than normal and if the highlighting is color, the color will start to change. The following is an example for such a function.

Let p be a phrase. The aim is to compute the function fₚ(i) which returns a score for phrase p on page i.
Let dfₚ be the document frequency of p.
Let tfₚ(i) be the frequency of phrase p on page i.
Let k be a constant—when calculating the value fₚ(i), pages from i−k up to i+k will be taken into consideration.
Let tfidfₚ(i)=tfₚ(i)/dfₚ

First calculate a function gₚ taking into consideration nearby pages, but giving greater weight to pages nearer to i.

gₚ(i)=Σ_{i-k≦j≦i+k}(tfidfₚ(j)*(k−|j−i|)²)

Let maxgₚ be the maximal value of the function gₚ(i) for all i in the text. Then fₚ(i) is obtained by normalizing gₚ(i):

fₚ(i)=gₚ(i)/maxgₚ

### Choosing a List of Phrases for the Cloud

The choice of phrases to appear in the cloud is crucial. The phrases should satisfy several properties:
They should be phrases that readers might be interested in.
Their fₚ(i) value should vary across the book. If the value does not vary then its size will not change in the cloud animation, and this would not help the user to navigate in the book. For example, for a book about Socrates, the word “Socrates” would not typically be a good word, even thought it appears numerous times in the book, because it does not help us to find out which page is of greater interest, since all the pages are about Socrates.

Automatically finding good phrases is difficult. This is complicated by the fact that the same topic may be discussed using different synonymous or related words. This may be partially solved by aggregating the functions of the two different phrases, and choosing one to represent them both.

Algorithms for automatically constructing a list of phrases can be taken from several areas of research in computer science. Methods for extracting keywords can be used directly. Methods for text summarization use techniques such as term frequency and document graphs which may be used to construct phrase lists. Alternatively, the automatic text summaries can be used as an input for other algorithms which would extract keywords from the summary. Text segmentation is the task of determining the positions at which topics change in a stream of text—such segmentation can be used as an input for further processing to determine which phrases are most representative of each segment.

The alternative is to manually choose the phrases. It is possible for the author to go over his book and manually choose appropriate phrases to appear in the cloud—similar to how some authors have to decide which words to include in an index. However, this method is more time intensive.

Either of these possibilities can be used; however, another practical way of defining the set of phrases is suggested. This is a phrase choice tool which goes over the book, and sorts phrases automatically according to various criteria. However, it is up to the author to choose which phrases will eventually appear in the cloud. The tool offers lists of words and phrases sorted according to several criteria, for example:
Frequency in entire document; and
Variance. For example,
   Let p be a phrase,
   Let n be the number of pages in the book.
   Let mean μₚ=(Σ_{1≦i≦n} fₚ(i))/n
   Sample variance s(p)=(Σ_{1≦i≦n} (fₚ(i)−μₚ)²)/n
      The lists can be limited to certain grammatical parts of text, such as verbs or nouns.

The tool may offer the following functionality to the author.
1. The author can request a list of phrases to be presented and sorted according to a chosen criterion. The author can then choose phrases from the list and add them to the list of phrases which is to be included in the cloud. The author can also sort the phrases he specified to be included in the cloud, since the final user may resize the window and thus not all the phrases would be presented. The phrases which appear first in the sort will have preference in being shown to the user in case the window cannot accommodate all the phrases.
2. Possible lists of words/phrases could be: frequent words, frequent verbs, frequent nouns, words with high variance, words which appear in the index of the book, etc
3. The tool should allow the author to specify which words should actually be considered together as a larger phrase.
4. The tool would allow the animation of the cloud to be shown.
5. The tool would allow the author to indicate which words/phrases are related, or synonymous to a degree that their functions should be combined.

Combining functions can be done as follows. Let Q be a set of related phrases, and let w be a phrase from Q which is chosen to represent all of Q. Then the value of the scoring function for w can be recalculated, for each page i:

f_{w}(i)=Σ_{q⊂Q}f_{q}(i)

### Layered Embodiment—Choosing Phrases for Each Layer

To animate the layered embodiment, it needs to be decided which phrases will appear in which layers.

By analyzing the function of each phrase, it can be determine in which layer the phrase would be most appropriate. Some possible measures of a phrase are:
The percent of pages in which the function for the phrase is greater than zero. The aim would be to put phrases with larger percentages into higher layers.
The number of non-zero segments. Such a segment is a range of pages where the value of the function is greater than zero inside the segment, and exactly zero in the pages before, and after the segment. The aim would be to put phrases with more segments in higher layers. The rationale is that more segments imply that the phrase may be of interest in more places in the book.

Let m(p) be a function over phrases which uses either one of the measures above, a similar measure, or a combination of them. If the desired number of layers is determined in advance, and it is known which phrases are to be included in the cloud, m(p) can be used to assign phrases to layers.

This could be integrated in the phrase choice tool. The author would be able to request the sorting of the phrases into layers by setting thresholds for each layer. For example, the author could say that the top layer should include only a specific fraction (e.g. 10%) of the phrases—this would sort the phrases such that the top tenth (when sorted by m(p)) of the phrases are placed in the top layer.

### Deciding Which Phrases to Show for Each Page, in a Cloud or Layer

There may be a large list of phrases, too large to fit in the allotted space in the user interface. There are two options for animating a cloud (or a layer of a cloud). Either the same set of phrases is displayed for all pages (so we have to choose a smaller set from the large list), or more phrases are presented by allowing the set of phrases to change across pages. For the latter option it needs to be decided:
1. which of the phrases to show on each page; and
2. in which location they should appear inside the cloud.

1. Determination of Which Phrases Should be Shown for a Page:

It is supposed that a list of phrases is provided for a given layer; however, at each point only some of the phrases will be presented, as space allows. This space may change according to the size of the window. Thus calculating which phrases should appear for each page in a book, should be done just before animating the cloud.

Let S be the set of phrases which are to be used to display a cloud (or layer). Let c be the number of phrases for which there is place for. Thus, the decision of which phrases to show in each page i of the book can be given as a function H(i), whose range is a subset of S, where the subset is of size c. These c phrases will be chosen such that they are maximal according to some measure.

A naive measure to use is simply fₚ(i). However, this may cause much discontinuity in animation. Two phrases may have fₚ values which alternate in peaks. Using the fₚ measure for choosing the phrases may cause these two phrases to repeatedly replace each other in the animation. Instead, it would be preferable to choose one of them only.

The problem with simply using fₚ(i) is that it only considers the local values in page i, and not the surrounding context. One option is to generate a new function, Gp(i), which assigns values according to continuous segments of pages for which the value of fₚ is non zero. These segments can be located, assigned values to, and then for each page, i, in the segment, assign Gp(i) to that value. An algorithm for generating the function Gp(i) would be as follows
1. for all pages i, set Gp(i) to 0
2. loop over non-zero segments, setting j,k to the start and end pages of the non zero segment, respectively
3. let val=calculate_measure(j,k)
4. for m=j to k, Let Gp(i)=val

There are numerous options for the function calculate_measure(j,k), for example: the maximal value of fₚ(i), where j≦i≦k
1. Σ_{j≦i≦k}:fₚ(i)
2. j−k—the number of pages in the segment.

Using Gp should provide smoother animation.

2. Determination of Locations Where Phrases Should Appear Inside the Cloud:

Initially, the phrases in a cloud could be sorted alphabetically. Moving from one page to the next, a set of phrases may need to be replaced. Each new phrase would take the place of one old phrase which would be omitted.

The disclosed implementation of phrase clouds provides smooth animation, and can be skimmed more quickly than other solutions. Smooth animation is achieved by keeping the phrases in the cloud approximately in the same place and just changing their highlighting such as their sizes and/or colors.

A skimming application alone or as part of a viewer application may be provided as a service to a customer over a network.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

The invention can take the form of a computer program product accessible from a computer-usable or computer-readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read only memory (ROM), a rigid magnetic disk and an optical disk. Current examples of optical disks include compact disk read only memory (CD-ROM), compact disk read/write (CD-R/W), and DVD.

Improvements and modifications can be made to the foregoing without departing from the scope of the present invention.

We claim:

1. A method for navigation of text, comprising:
providing a linear text in electronic form;
displaying a plurality of phrases representing the content of the text;
emphasizing a displayed phrase to indicate the relevance of the phrase in a predefined portion of the text; and
animating the display of phrases to show changes in the emphasizing during progression through the linear text.

2. The method as claimed in claim 1, wherein when a phrase is present in the display of phrases, the phrase is kept in the same position in the display during the animation.

3. The method as claimed in claim 1, wherein phrases are added to and removed from the display during progression through the text, and the method includes minimizing discontinuity of the animation.

4. The method as claimed in claim 1, wherein a predefined portion of the text is a browsing unit and the relevance of the phrase is smoothed over neighbouring browsing units.

5. The method as claimed in claim 1, wherein the relevance of a phrase to a predefined portion of the text is determined by a relevance algorithm based on the frequency of occurrence of the phrase.

6. The method as claimed in claim 1, including generating a plurality of phrases representing the content of a text.

7. The method as claimed in claim 1, wherein emphasizing a displayed phrase and animating changes in emphasis include one or more of the group of: emphasizing the phrase in a color and changing the tone or strength of the color; emphasizing the size of the phrase and changing the size; emphasizing a background color of a phrase and changing the tone or strength of the background color; emphasizing a font of the phrase and changing the font type, or amount of bold, italics or underline.

8. The method as claimed in claim 1, wherein emphasizing a displayed phrase includes a graphical indication of an increase or decrease in relevance compared to neighbouring areas of text.

9. The method as claimed in claim 1, wherein emphasizing a displayed phrase includes a graphical indication of whether the phrase occurs in the predefined portion of text.

10. The method as claimed in claim 1, wherein stopping progression through the text activates a display of the text at the current position of the progression.

11. The method as claimed in claim 1, wherein displaying a plurality of phrases representing the content of the text includes displaying the phrases in at least two layers, a first layer including phrases relevant to the entire text, and one or more subsequent layers including phrases relevant to portions of the text.

12. The method as claimed in claim 1, wherein selecting a phrase in the display provides additional information and navigation options.

13. A system for navigation of linear text in electronic form, comprising:
a user interface for displaying a plurality of phrases representing the content of the text, including means for progressing though the linear text;
means for emphasizing a displayed phrase to indicate the frequency of the phrase in a predefined portion of the text; and
means for animating the display of phrases to show changes in the emphasizing during progression through the linear text.

14. The system as claimed in claim 13, wherein the user interface includes:
a display of the phrases;
a display of the linear text;
navigation means for moving through the linear text; and
animation control means.

15. The system as claimed in claim 14, wherein the user interface further includes a graph showing the phrase occurrences through the linear text.

16. The system as claimed in claim 14, wherein the display of the phrases consists of at least two layers, a first layer including phrases relevant to the entire text, and one or more subsequent layers including phrases relevant to portions of the text.

17. The system as claimed in claim 13, including means for interacting with a text viewer application to navigate through the linear text viewed by the text viewer application according to a selected position in the display of phrases.

18. A computer program product stored on a computer readable storage medium for navigation of text, comprising computer readable program code means for performing the steps of:
providing a linear text in electronic form;
displaying a plurality of phrases representing the content of the text;
emphasizing a displayed phrase to indicate the frequency of the phrase in a predefined portion of the text; and
animating the display of phrases to show changes in the emphasizing during progression through the linear text.
